(19) United States
(12) Patent Application Publication
(10) Pub. No.: US 2017/0011301 A1
(43) Pub. Date: Jan. 12, 2017

(54) CAPTURING, ENCODING, AND EXECUTING KNOWLEDGE FROM SUBJECT MATTER EXPERTS

(71) Applicant: General Electric Company, Schenectady, NY (US)

(72) Inventors: Abha Moitra, Scotia, NY (US); Arvind Rangarajan, San Ramon, CA (US); Ravi Kiran Reddy Palla, Niskayuna, NY (US)

(21) Appl. No.: 14/795,611

(22) Filed: Jul. 9, 2015

(51) Int. Cl. G06N 5/04; G06N 99/00

(52) U.S. Cl. CPC G06N 5/046; G06N 99/005

(57) ABSTRACT

In various example embodiments, a semantic modeling server includes a semantic model and an inductive logic programming module. The semantic module includes underlying data that defines one or more characteristics of a part to be manufactured. The inductive logic programming module is provided with positive and negative examples of a feature to be identified and part data that defines the part to be manufactured. Given the examples of the feature and the semantic model, the inductive logic programming module determines various rules that can be used to identify whether the provided part data includes the feature defined by the semantic model. Using the determined rules the inductive logic programming module then identifies instances of the feature associated with the semantic model within the provided part data. The inductive logic programming can then be iteratively executed with the semantic model to refine the determined rules.

### TECHNICAL FIELD

Embodiments of the present disclosure relate generally to data processing and analysis and, more particularly, but not by way of limitation, to systems and methods for capturing, encoding, and executing knowledge from subject matter experts.

### BACKGROUND

A subject matter expert typically has a depth of knowledge about a given subject matter. However, capturing such knowledge from the subject matter expert is generally a time-consuming process and often requires a number of iterations between a questioner and the subject matter expert for a consensus to be reached. This is partly due to the fact that the questioner and the subject matter expert attempt to reach a shared understanding and interpretation of domain concepts and relationships.

A semantic model can sometimes help in defining the knowledge held by the subject matter expert. Such knowledge may be defined by one or more rules of the semantic model. However, while a semantic model sometimes provides a starting point for this shared understanding, the subject matter expert may not be versed in formulating the underlying rules of the semantic model to effectively represent the knowledge the expert possess. Furthermore, the questioner may be at a disadvantage in formulating the rules because he or she may not have a deep understanding of the topic associated with the semantic model. While some solutions leverage a semantic modeler and subject matter expert working together to develop the rules of the semantic models, such arrangements are not always feasible or possible.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked environment, in accordance with one embodiment, in which a semantic modeling server is in communication with various client devices.

FIG. 2 is a block diagram illustrating the components of the semantic modeling server of FIG. 1 in accordance with an example embodiment.

FIG. 3 is a block diagram illustrating the various data components of a semantic model in accordance with an example embodiment.

FIGS. 4A-4C illustrate defining and refining a semantic model in accordance with an example embodiment.

FIGS. 5A-5B illustrate a method, in accordance with an example embodiment, for defining and refining a semantic model via the semantic modeling server of FIG. 1.

FIG. 6 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, this disclosure provides systems and methods directed to capturing and modeling information held by one or more subject matter experts. In one embodiment, the systems and methods includes defining one or more predicates and properties for a semantic model, and then receiving labeled instance data from one or more subject matter experts identifying positive or negative examples of an object defined by the semantic model.

In one example, the disclosed systems and methods are directed to defining one or more semantic models corresponding to features in a part to be manufactured. In this example, the part, such as a brake pad, piston, cam shaft, or other such part, includes one or more instances of various features. Accordingly, the underlying predicates and properties of the semantic models define vertices, edges, and faces of the various features. A user then identifies positive and/or negative examples of a feature to be defined based on the underlying vertices, edges, and faces. Given the positive examples, negative examples, and the semantic model, an inductive logic programming (“ILP”) module is configured to generate one or more Horn clause-based rules, which are then used by the ILP module to separate out positive and negative instances of the feature appearing in the part to be manufactured.

The generated one or more Horn clause-based rules are then incorporated into the semantic model, and the instances identified by the ILP module are reviewed for accuracy. Where there are inaccuracies (e.g., false positives), the inaccuracies are re-labeled and the ILP module is then executed again with the semantic model, which includes the Horn clause-based rules and the underlying data defining the vertices, edges, and faces. Again, instances labeled by the ILP module (e.g., positive and/or negative instances) are then reviewed again for accuracy. In this iterative manner, the ILP module can be used to refine the rules defining the semantic model associated with a given feature. The refined semantic model, corresponding to a given feature, can then be applied to data defining a part to be manufactured to identify one or more instances of the feature appearing within the part to be manufactured.

The technical effect of the disclosed systems and methods is that a user can quickly and effortlessly identify the features in a designed part. Furthermore, the disclosed systems and methods can be used to confirm that the features appearing in a designed part conform to a known definition of the feature. In other words, the user avoids the pitfalls of designing a part having one or more features that are non-conforming. This is useful so that the user does not submit a design for a given part that cannot be manufactured (e.g., due to design flaws or practical limitations).

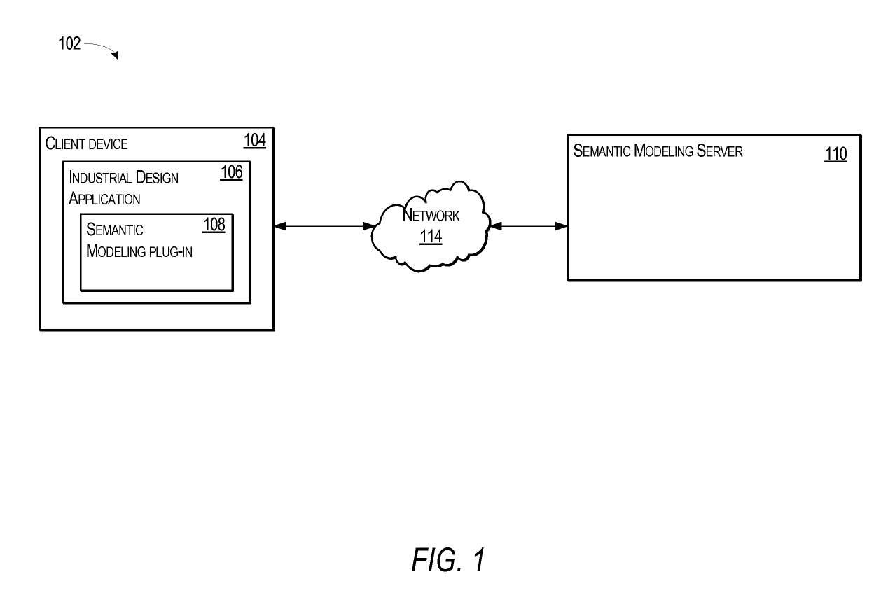

Referring to FIG. 1, is a block diagram illustrating a networked environment 102, according to one embodiment, in which a semantic modeling server 110 is in communication with a client device 104 via a network 114. The semantic modeling server 110 provides server-side functionality via the network 114 (e.g., a local area network) to the client device 104. The client device 104 is configured to execute a client application 106 that access resources available from the semantic modeling server 108. Examples of such applications include a web client (e.g., a browser, such as the Internet Explorer® browser developed by Microsoft® Corporation of Redmond, Washington State), an application, or a programmatic client. In one embodiment, the client device 104 is configured with an industrial design application 106 for designing and defining parts (e.g., automobile parts) to be manufactured. One example of an industrial design application 106 is Siemens NX, which is available from Siemens PLM Software, located in Munich, Germany. Using the industrial design application 106, a user of the client device 104 designs a part to be manufactured, such as a brake pad, engine block, piston, or other such part. The part data defines the part to be manufactured, and includes one or more features that constitute the part. Examples of features that may constitute a part include, but are not limited to an interior fillet, a pad, a flange, a groove, a pad fillet, a spherical fillet, an interrupted fillet, a variable fillet, and other such features or combination of features.

In addition, the industrial design application 106 is configured with a semantic modeling plug-in 108, which interfaces with the industrial design application 106. In one embodiment, the semantic modeling plug-in 108 is written in a computer-programming or scripting language such as C++, Java, Visual Basic, C#, or other such computer-programming or scripting language and is configured to interact with the industrial design application 106.

The semantic modeling plug-in 108 provides a graphical and/or text-based user interface to a user of the client device 104 for selecting positive and/or negative examples of a feature (e.g., an interior fillet) of a part to be manufactured (e.g., an automobile brake pad) designed using the industrial design application 106. Positive examples of feature include those examples where the feature is shown or represented in the part to be manufactured; negative examples are those where the feature is not shown or is a different feature. In one embodiment, a user selects those portions of the part to be manufactured as the positive and negative examples of a feature to associate with a corresponding semantic model. In another embodiment, the semantic modeling plug-in 108 randomly, or pseudo-randomly, selects portions of the part to be manufactured, and requests that the user identify the selected portions as the positive or negative examples.

The feature selections (e.g., the positive and negative examples) made by or with the semantic modeling plug-in 108 are submitted to the semantic modeling server 108 for defining a semantic model corresponding to the feature to be defined. In addition, the part data representing the part to be manufactured is submitted to the semantic modeling server 108, which may also include an instruction to identify instances of the feature, corresponding to the submitted positive and/or negative examples, in the submitted part data.

The client device 104 may comprise, but is not limited to, one or more mobile phones, desktop computers, laptops, portable digital assistants (PDAs), smart phones, tablets, ultra-books, netbooks, laptops, multi-processor systems, microprocessor-based or programmable consumer electronics, or any other communication device that a user may utilize to access the resources available from the semantic modeling server 110. In some embodiments, the client devices 104 may comprise a display module (not shown) to display information (e.g., via the industrial design application 106 and/or the semantic modeling plug-in 108). In further embodiments, the client device 104 may comprise one or more of a touch screens, accelerometers, gyroscopes, cameras, microphones, global positioning system (GPS) devices, and so forth. The client device 104 may be a device of a user that is used to access a profile (e.g., a user profile) associated with the user and maintained by the semantic modeling server 110.

One or more users of the client device 104 may be a person, a machine, or other means of interacting with the client device 104. In various embodiments, the users of the client device 104 are not part of the network environment 102 shown in FIG. 1, but may interact with the semantic modeling server 110 via the client device 104 or another means. For instance, the user provides input (e.g., touch screen input or alphanumeric input) to the client device 104 and the input is communicated to the semantic modeling server 110 via the network 114. In this instance, the semantic modeling server 110, in response to receiving the input from the user, communicates information to the client device 104 via the network 114 to be presented to the user. In this way, the user can interact with the semantic modeling server 110 by using the client devices 104.

The network 114 may include a variety of networks for facilitating communications between the client device 104 and the semantic modeling server 110. For example, networks 114 include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks. In one embodiment, the network 114 defines an intranet that communicatively couples the client device 104 and the semantic modeling server 110.

The client device 104 may include one or more applications (also referred to as “apps”) such as, but not limited to, a web browser, messaging application, electronic mail (email) application, a social networking application, and the like. In some embodiments, if the industrial design application 106 and/or the semantic modeling plug-in 108 is included in the client device 104, then this application 106 is configured to locally provide a user interface and at least some of the functionalities to communicate with the semantic modeling server 110, on an as needed basis, for data and/or processing capabilities not locally available. Conversely if the industrial design application 106 and/or the semantic modeling plug-in 108 are not included in the client device 104, the client device 104 may use a web browser or other networking application (e.g., a Remote Desktop Client application) to access the semantic modeling server 110.

The semantic modeling server 110 includes one or more applications and/or resources for defining a semantic model associated with a given feature and/or part to be manufactured. In summary, the semantic modeling server 110 includes initial part data that forms the basis for an initial semantic model of a given part. The part data defines various characteristics for the given part, such as vertices, edges, and faces. The semantic modeling server 110 also includes an ILP module which, when invoked, determines logic rules for identifying the target feature from more complex part data that potentially includes multiple instances of the given feature, where the ILP module leverages the semantic model and examples of the target feature to determine the corresponding rules.

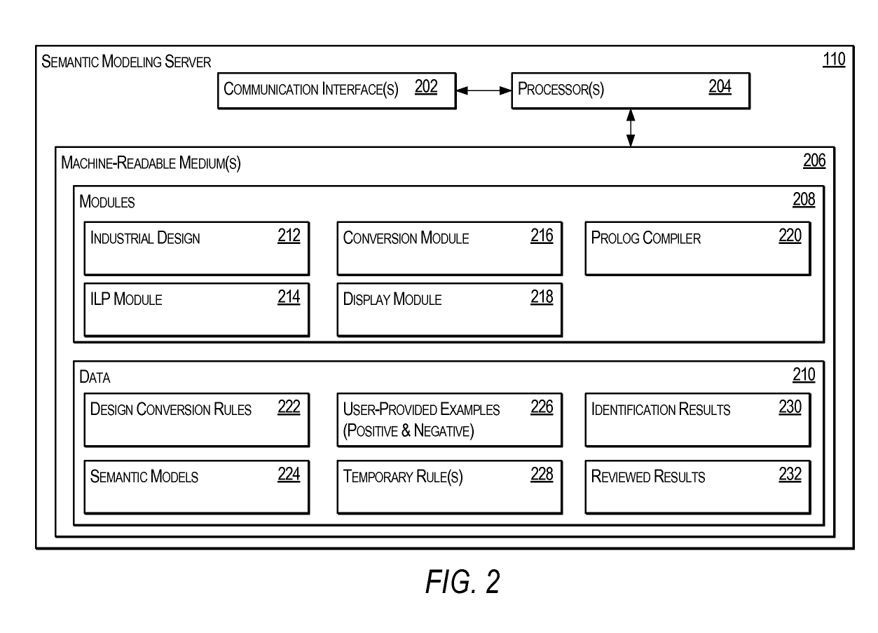

FIG. 2 is a block diagram illustrating the components of the semantic modeling server 110 of FIG. 1 in accordance with an example embodiment. In one embodiment, the semantic modeling server 110 includes one more communication interfaces 202 in communication with one or more processors 204. The one or more processors 204 are communicatively coupled to one or more machine-readable mediums 206, which include modules 208 for implementing the disclosed semantic modeling server 110 and data 210 to support the execution of the modules 208.

The various functional components of the semantic modeling server 110 may reside on a single device or may be distributed across several computers in various arrangements. The various components of the semantic modeling server 110 may, furthermore, access one or more databases, and each of the various components of the semantic modeling server 110 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the semantic modeling server 110 and the client device 104. The one or more communication interfaces 202 may include one or more wired interfaces (e.g., an Ethernet interface, Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combination of such wired and wireless interfaces.

The machine-readable medium 206 includes various modules 208 and data 210 for implementing the disclosed semantic modeling server 110. The machine-readable medium 206 includes one or more devices configured to store instructions and data temporarily or permanently and may include, but is not be limited to, random-access memory (RAM), read-only memory (ROM), buffer memory, flash memory, optical media, magnetic media, cache memory, other types of storage (e.g., Electrically Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as a “cloud-based” storage systems or storage networks that include multiple storage apparatus or devices. As shown in FIG. 2, the machine-readable medium 206 excludes signals per se.

In various embodiments, the modules 208 include an industrial design module 212, a conversion module 216, a Prolog compiler 220, an inductive logic programming module 214, and a display module 218. While FIG. 2 illustrates modules 212-218 as separate modules, one of ordinary skill in the art will recognize that such modules 212-218 may be implemented in alternative arrangements.

In addition, in various embodiments, the data 210 includes one or more design conversion rules 222, one or more semantic models 224, user-provided examples 226 of positive examples of a given feature and negatives examples of a given feature, one or more temporary rules 228 (e.g., rules that are, or can be, refined prior to their final inclusion in a given semantic model 224), identification results 230, and reviewed results 232.

With reference to FIG. 1, the industrial design module 212 is configured to interact with the industrial design application 104 of the client device 104. In particular, the industrial design module 212 is configured to receive the part data that defines a part designed using the industrial design application 106. In alternative embodiments, the industrial design module 212 implements the industrial design application and is accessible via the client device 104. Referring to the data 210, the design conversion rules 222 include one or more rules that facilitate the conversion of data from a format used by the industrial design application 106 to a format used by the Prolog compiler 220 and/or the ILP module 214. As the part data may be in a format native to the industrial design application 104, the semantic modeling server 110 includes a conversion module 216 configured to convert the part data received from the native format of the industrial design application to a format understandable by the ILP module 214.

In one embodiment, the format part data is a native Siemens NX file, an AutoCAD file (e.g., a .CAD file), or other such format used in industrial design, and the conversion module 216 converts the first format to a second format understandable by the Prolog compiler 220, such as the Prolog language, which one of ordinary skill in the art would understand to be a general purpose logic programming language. As alluded to above, to convert the first format (e.g., the industrial design format) to the second format (e.g., the logic programming language format), the conversion module 216 invokes one or more of the design conversion rules 222, which provide the requisite logic and semantics for the conversion process. In alternative embodiments, the conversion module 216 may be further configured to convert the data output by the ILP module 214, such as the positive and negative instance data, to a format understandable by the industrial design application 106. This conversion may be performed such that a user may view the positive and negative instances within the industrial design application 106 via the semantic modeling plug-in 108. Thus, the conversion module 216 facilitates the interactions between the industrial design application 106 executable by the client and the ILP module 214.

In alternative embodiments, the conversion of the first format to the second format is performed by the client device 104. In other words, the semantic modeling plug-in 108 may be configured to convert the industrial design application format to the general purpose logic programming language format. In this way, the client device 104 provides the functionality of packaging the part data of the industrial design application 106 in a format understandable by the Prolog compiler and the ILP module 214.

The Prolog compiler 220 provides an environment in which to execute the ILP module 214. In one embodiment, the ILP module 214 is the A Learning Engine for Proposing Hypotheses (“ALEPH”), which is available from the University of Oxford, located in Oxford, England. ALEPH is a machine learning module that uses logic programming (e.g., the Prolog language) as a uniform representation for examples, background knowledge and hypotheses. Given an encoding of the known background knowledge and a set of examples represented as a logical database of facts, ALEPH derives a model that identifies positive examples from the set of examples conforming to a determined set of rules. However, as ALEPH may identify some positive examples incorrectly (e.g., as false positives), the process of deriving the model may be iterative.

As one of ordinary skill in the art will recognize, the Prolog compiler 220 may be implemented as any logic programming language compiler such as SWI-Prolog, GNU Prolog, Visual Prolog, and other such Prolog compilers. Furthermore, as one of ordinary skill in the art will also recognize, the ILP module 214 is not limited to ALEPH, but may include any inductive logic programming module. Other ILP modules that may be used as the ILP module 214, include ILP modules such as Atom, Claudien, DMax, Foil, or other such inductive logic programming engine.

In addition, depending on the ILP module used, the semantic modeling server 110 may include additional or alternative computing environments in which the ILP module 214 executes. For example, where the ILP module 214 is Atom, the semantic modeling server 110 is configured with Microsoft Visual Studio 2013. In other words, the semantic modeling server 110 includes the computing environment in which the ILP module 214 executes (if needed), and, as shown in FIG. 2, the computing environment in this embodiment is a Prolog compiler 220.

The client device 104 may interact with the semantic modeling server 110 to execute and/or invoke the ILP module 214. For example, in one embodiment, the client device 104 invokes the Prolog compiler 220 and/or ILP module 214 via the semantic modeling plug-in 108, which may include instruction and/or function calls for controlling the Prolog compiler 220 and/or ILP module 214. In this manner, a user of the client device 104 interacts with the industrial design application 106 to design a part, selects positive and/or negative examples of a feature represented in the part, and then invokes the ILP module 214, via the semantic modeling plug-in 108, to formulate rules for a semantic model corresponding to the feature. In an alternative embodiment, the Prolog compiler 220 and/or ILP module 214 is invoked outside of the context of the industrial design application 106, such as via a web browser or other remote desktop application.

As discussed above, the semantic modeling server 110 includes semantic models 224, where a semantic model can be configured, via the ILP module 214, to correspond to a given feature. As understood by one of ordinary skill in the art, a semantic model consists of concepts, properties of the concepts, relationships between concepts and instance data. With reference to FIG. 1, and in one embodiment, a user may use the industrial design application 106 to define a semantic model for each feature appearing in a given part.

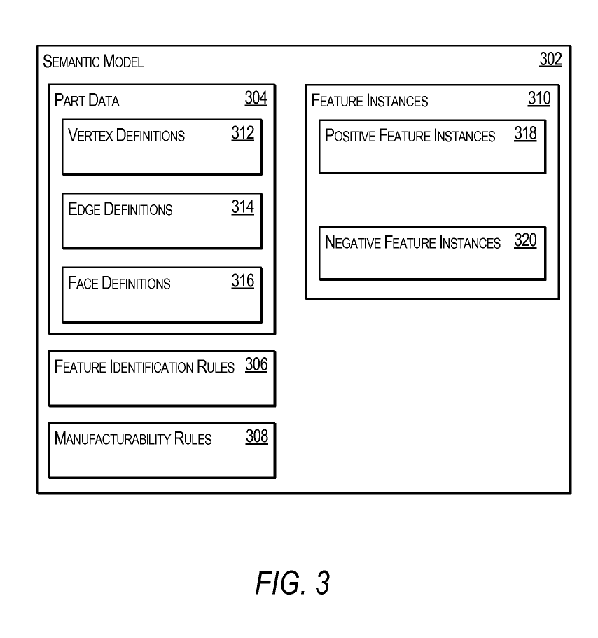

FIG. 3 is a block diagram illustrating the various data components of a semantic model 302 in accordance with an example embodiment. In one embodiment, the semantic model includes part data 304, feature identification rules 306, manufacturability rules 308, and feature instances 310. In other embodiments, the semantic model 302 includes different or alternative data components.

The part data 304 includes data that defines the basic components of the entire part to be manufactured. In particular, and in one embodiment, such part data 304 includes vertex definitions 312, which may be expressed as coordinates, such as three-dimensional coordinates, edge definitions 314, which may be expressed as one or more vertices, and face definitions 316, which may be expressed as one or more edges. In one embodiment, the part data 304 is particular to a part designed with the industrial design application 106. Thus, when a given part is designed with the industrial design application 106, the part data 304 is derived from the data used to design the part, either automatically (e.g., programmatically by the industrial design application 106 and/or semantic modeling plug-in 108), manually (e.g., by the user labeling each individual vertex, edge, and/or face), or both. In another embodiment, the part data 304 is generic to the part designed with the industrial design application 106 such that the individual components 312-316 are expressed as generic relationships (e.g., a vertex is a single point, an edge is one or more vertices, etc.).

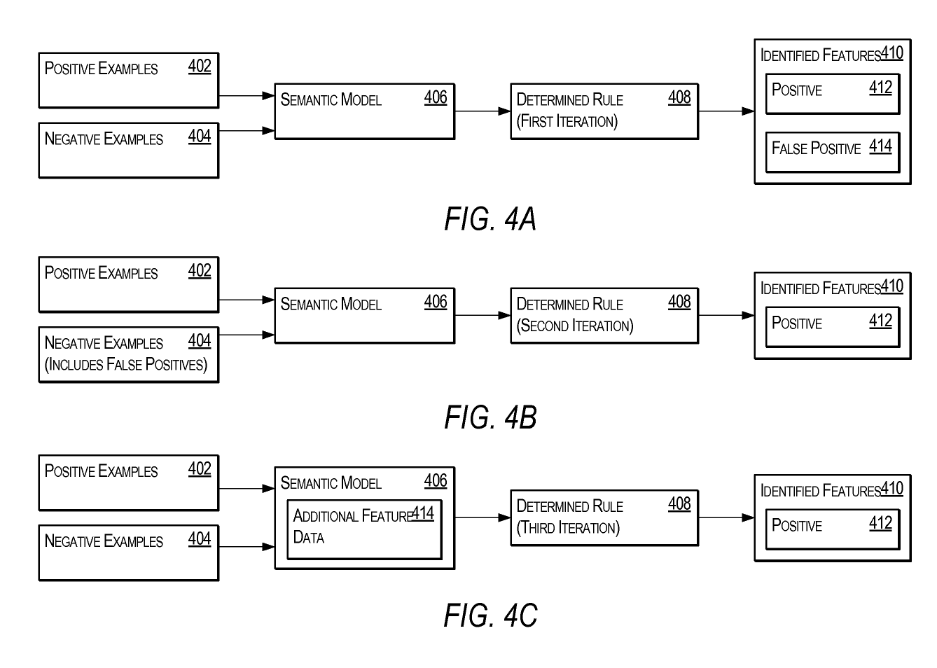

The feature identification rules 306 include one or more rules that define whether a collection of the part data of the part to be manufactured, includes one or more instances of the feature corresponding to the semantic model 302. When a semantic model 302 is first initialized, there may be no feature identification rules 306; more specifically, an initial semantic model 302 may or may not include any features. However, after the ILP module 214 is invoked and provided with the semantic model 302 and positive examples and negative examples of a specific feature (e.g., the user-provided examples 226), the ILP module 214 determines the feature identification rules 306. As discussed below with reference to FIGS. 4A-4C, the feature identification rules 306 can be further refined depending on whether evaluation of part data, with a given semantic model 302, results in false positives of a given feature. In one embodiment, the refinement of the feature identification rules 306 is performed by the ILP module 214. Additionally or alternatively, the feature identification rules 306 can be subject to inspection such that one or more of the rules 306 are manually refined by a user of the client device 104.

The manufacturability rules 308 include one or more rules that define whether a collection of feature data, such as the part data of the part to be manufactured, can be manufactured. For example, the manufacturability rules 308 may include rules directed to thickness tolerances, curvature limitations, angle constraints, height and/or width constraints, material tolerances, and other such rules.

As with the feature identification rules 306, the manufacturability rules 308 are determined via the ILP module 214 when provided with positive and negative examples of the feature corresponding to the semantic model 302 and the initial feature data 304. While the manufacturability rules 308 are illustrated as being separate from the feature identification rules 306, in alternative embodiments, the feature identification rules 306 and the manufacturability rules 308 are implemented as one collection of rules. Furthermore, in some embodiments, a semantic model 302 may include only the feature identification rules 306 or only the manufacturability rules 308. As with the feature identification rules 306, the manufacturability rules 308 can be automatically refined via successive iterations of the ILP module 214 or manually refined via user interactions.

The feature instances 310 include positive feature instances 318 and negative feature instances 320 of the feature corresponding to the semantic model 302. Positive feature instances 318 include those instances where the feature is represented; conversely, negative feature instances 320 include those instances where the feature is not represented. In one embodiment, the positive feature instances 318 and the negative feature instances 320 are incorporated into the semantic model 302 from the user-provided examples 226. As one of ordinary skill in the art will understand, the ILP module 214 leverages the feature instances 318 along with the feature data 304 to determine and/or refine the feature identification rules 306 and/or the manufacturability rules 308. In this way, the feature instances 310 guide the ILP module 214 in determining rules 306,308 that yield results conforming to the positive feature instances 318.

Referring back to FIG. 2, the data 210 also includes identification results 230 and reviewed results 232. The identification results 230 are those instances of a feature, both positive and negative, that the ILP module 214 has determined when provided with a semantic model and part data from the industrial design application 106. In some scenarios, such as where the semantic model is being developed, some of the identification results 230 may be incorrect. In other words, the identification results 230 may include positive instances that should have been identified as negative instances and negative instances that should have been labelled as positive instances. In these scenarios, a user may review the identification results 230 and re-classify them correctly. The reclassified results correspond to the reviewed results 232. The reviewed results 232 may then be fed back into the ILP module 214, along with the part data and the corresponding semantic model, which the ILP module 214 then uses to refine the rules of the semantic model. In this manner, successive iterations of the ILP module 214 with a given semantic model can result in more refined rules (e.g., feature identification rules and/or manufacturability rules) that more accurately identify whether a given set of part data includes positive instances of the feature corresponding to the given semantic model.

FIGS. 4A-4C illustrate defining and refining a semantic model in accordance with an example embodiment. For the purposes of this example, assume that a part has been designed with the industrial design application 106, and that the part data defines a known number of a known feature; in this example—41 interior fillets. Starting with FIG. 4A, and with reference to FIG. 2, a semantic model 406 is loaded into the ILP module 214, along with various positive examples 402 (e.g., 12 positive examples) and negative examples 404 (e.g., 10 negative examples) corresponding to a feature to be associated with the semantic model 406. The positive examples 402 and negative examples 404 may correspond to one or more of the user-provided examples 226. The ILP module 214 then determines a rule 408 that reflects the positive examples 402 and in view of the feature data (e.g., vertices, edges, and faces) associated with the semantic model 406. Below is one example of a rule that the ILP module 214 determines in accordance with the semantic model 406 and the provided examples 402,404:

interiorfillet(A) :-

facetype(A,surface_of_revolution),
adjacentface(A,B),
notconcave(B).

Each of the relationships shown in the “interiorfillet” rule, such as “facetype,” “adjacentface,” and “notconcave,” may be defined by the part data of the semantic model 406 (e.g., part data 304). Using this rule and its associated semantic model 406, the ILP module 214 then evaluates the part data to identify features (e.g., interior fillets) that conform to this rule. The resulting features are shown as identified features 410, where the identified features 410 include positive instances 412 and, for purposes of this example, false positive instances 414 (e.g., features that were identified as interior fillets but are not actually interior fillets). In this example, we assume that the ILP module 214 identifies 48 positive instances of an interior fillet from the part data; and 7 of the instances are false positives. This result means that the rule (e.g., interiorfillet(A)) is over-inclusive, and that it should be further refined. The false positives may be identified by having a user or other moderator review the positive instances identified by the ILP module 214.

Referring to FIG. 4B, is a second iteration of the ILP module 214. In this example, the negative examples 404 now include the false positives 414. Again, the positive examples 402 (e.g., the 12 positive examples) and the negative examples 404 (e.g., 17 negative examples, which include the original 10 negative examples and the 7 false positive examples) are provided to the ILP module 214, along with the semantic model 406 and the first iteration of the rule 408 determined in FIG. 4A. Accordingly, the ILP module 214 refines the rule 408 and modifies it, if needed, in view of the positive and negative examples 402,404. Below is an example of the rule 408 after having been refined (and/or re-determined) by the ILP module 214:

interiorfillet(A) :-

facetype(A,surface_of_revolution),
adjacentface(A,B),
notconcave(B),
adjacentface(A,C),
facetype(C,planar).

One of ordinary skill in the art will recognize that the “interiorfillet” rule now includes additional relationships, namely, the second “adjacentface” relationship and the second “facetype” relationship. With this refined rule 408, the ILP module 214 identifies interior fillets from the provided part data that conform to the refined rule 408. The ILP module 214 identifies these features as the identified features 410 and, in particular, the positive instances 412. In this example, we find that the ILP module 214 identifies 41 interior fillets, which corresponds to the known number of interior fillets of the provided part data. Accordingly, it can be concluded that an additional iteration of the ILP module 214 with the semantic model 406 is not needed.

FIGS. 4A-4B illustrate the utility of performing successive iterations of the ILP module 214 with the semantic model 406 where false positives are identified. However, there are also instances where an additional iteration of the ILP module 214 is helpful even when false positives are not identified. One example of such an instance is where the ILP module 214 identifies a set of vertices, edges, and/or faces as being multiple different features where, in fact, the set of vertices, edges, and/or faces actually define a single feature. This occurs in some instances as the ILP module 214 processes the provided part data and fails to recognize that a first set of faces (e.g., A, B, and C) are geometrically equivalent to a second set of faces (e.g., B, A, and C). Accordingly, it may be helpful to modify the underlying part data (e.g., part data 304) to rectify this misidentification.

FIG. 4C illustrates a situation where the underlying feature data for a given semantic model is modified (e.g., with additional feature data 414) and the ILP module 214 is executed with the modified semantic model 406 and the provided part data in accordance with an example embodiment. In the example of FIG. 4C, the feature data of the semantic model 406 is modified to include an additional relationship, namely a “notsharevertex” relationship. The rule 408 resulting from such modification is provided below:

interiorfillet(A) :-

facetype(A,surface_of_revolution),
adjacentface(A,B),
notconcave(B),
adjacentface(A,C),
facetype(C,planar)
notsharevertex(B,C).

In this manner, a successive iteration of the ILP module 214 with modified feature data helps refine the rule of the semantic model 406 defining the interior fillet, which can be then used to identify other interior fillets from other part data.

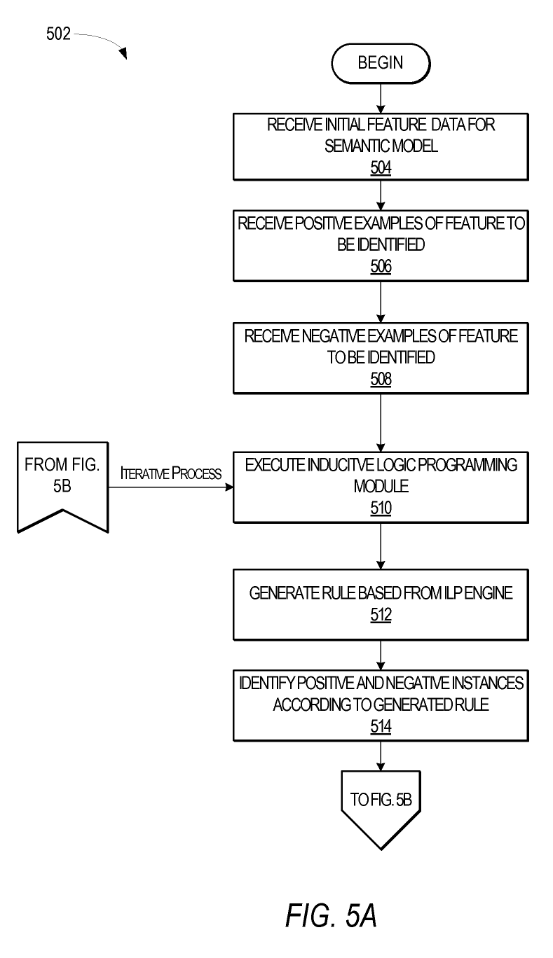

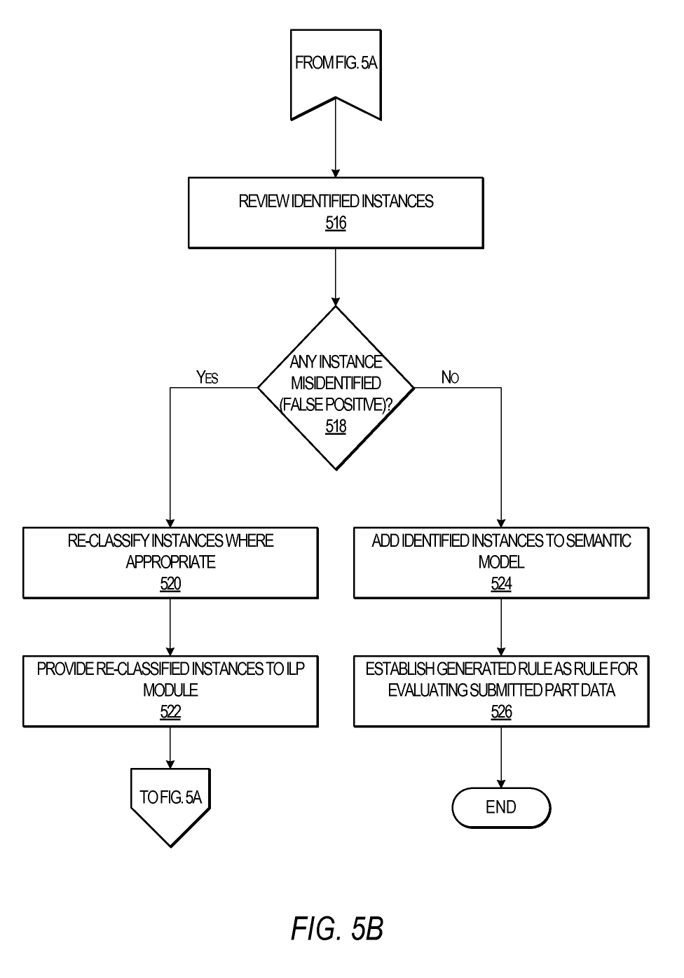

FIGS. 5A-5B illustrate a method 502, in accordance with an example embodiment, for defining and refining a semantic model via the semantic modeling server of FIG. 1. The method 502 may be implemented by one or more of the modules 208 of the semantic modeling server 110 and is discussed by way of reference thereto.

Initially, and with reference to FIG. 2, FIG. 3, and FIG. 5A, the semantic modeling server 110 receives initial feature data 304 for a semantic model 302 (Operation 504). As discussed above, such feature data 304 may include, but is not limited to, one or more vertex definitions 312, one or more edge definitions 314, and one or more face definitions 316.

The semantic modeling server 110 then receives positive examples of a feature to be identified (Operation 506) and negatives examples of the feature to be identified (Operation 508). As discussed previously, a user may use the interface provided by the industrial design application 106 and/or the semantic modeling plug-in 108 to select the positive and/or negative examples of the feature to be identified.

The ILP module 214 is then executed with the provided examples and the semantic model (Operation 510). The ILP module 214 then determines one or more rules for identifying the feature associated with the semantic model (Operation 512). Thereafter, the ILP module 214 uses the semantic model and provided part data (e.g., part data from the industrial design application 106) to identify instances of the feature corresponding to the semantic model (Operation 514). As discussed above with reference to FIG. 2, the identified instances, such as any positive and/or negative instances, are stored as the identification results 230. The identification results 230 may then be provided to the user of the client device 104, such as via the display module 218 or the industrial design module 212.

Referring to FIG. 5B, the identification results 230 are then reviewed (Operation 516). As discussed previously, reviewing the instances identified by the ILP module 214 is to ensure that none of the positive instances were misidentified and/or that none of the negative instances were misidentified. In this regard, a determination is made as to whether there were any misidentified instances (Operation 518). Where there are misidentified instances (e.g., “Yes” branch of Operation 518), the misidentified instances are re-labeled (Operation 520), and then re-submitted to the ILP module 214 (Operation 522). In this manner, execution of the ILP module 214 is reiterative based on whether the ILP module 214 misidentifies any positive or negative instances of the feature corresponding to the semantic model.

Where there are no misidentified instances (e.g., “No” branch of Operation 518), the identified instances are incorporated into the semantic model (Operation 524) and the rule generated by the ILP module 214 is established as a rule for it corresponding semantic model (Operation 526). The ILP module 214 may then use the semantic model in identifying features defined by provided part data designed using the industrial design application 106.

In this manner, the disclosed systems and methods provide an iterative mechanism by which a semantic model is established for a given feature defined by part data creating using an industrial design application. These systems and methods reduce the time and effort normally required to establish a rule-based evaluation system that determines whether a given feature is present in the part data. Furthermore, the disclosed systems and methods bridge the gap between a subject matter expert and a semantic modeler such that the semantic modeler does not need the depth of knowledge of the subject matter expert nor does the subject matter expert need the requisite knowledge to craft rules that define a specific feature. Thus, the disclosed systems and methods represent an advancement in semantic modeling and industrial part design.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5B are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Architecture and Machine-Readable Medium

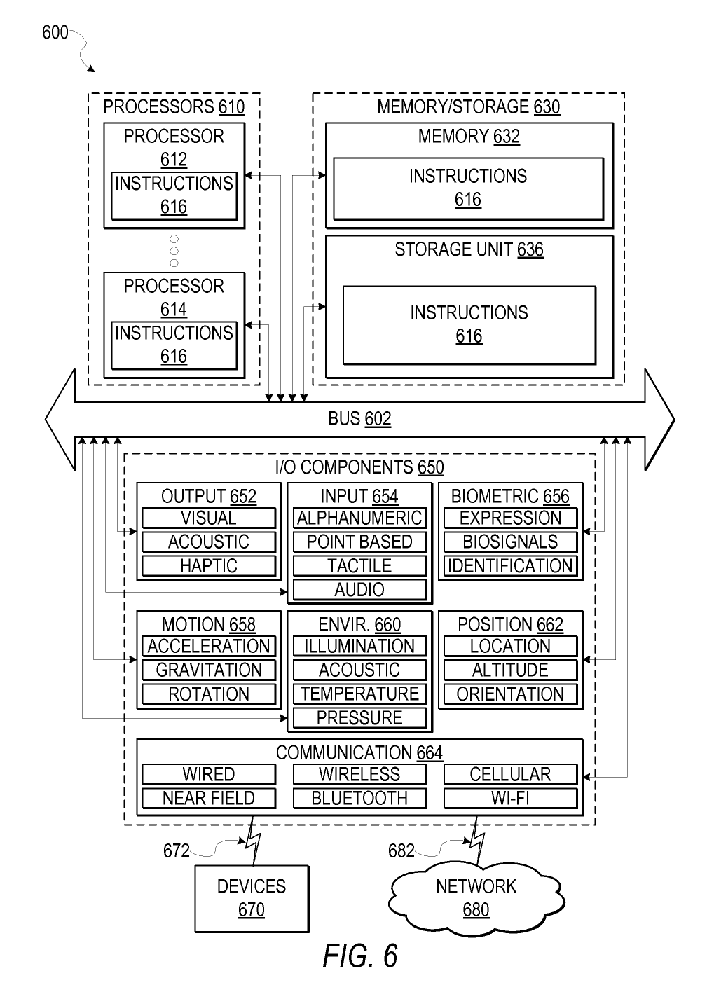

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions may cause the machine to execute the message passing or method diagrams of FIGS. 5-6. Additionally, or alternatively, the instructions may implement the modules 208 of FIG. 2. The instructions transform the general, non-programmed machine into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 612 and processor 614 that may execute instructions 616. The term “processor” is intended to include multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core process), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Electrically Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via coupling 682 and coupling 672 respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or other type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to devices 670. The term “transmission medium” shall be taken to include any intangible medium that is capable of storing, encoding, or carrying instructions 616 for execution by the machine 600, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium configured to store a semantic model, the semantic model comprising first part data that defines one or more characteristics for a part to be manufactured;
an inductive logic programming module, the inductive logic programming module configured to:
receive a first plurality of examples of a feature to be identified from the part to be manufactured;
receive second part data that defines the part to be manufactured;
determine at least one rule that identifies whether the second part data includes the feature to be identified, the at least one rule being determined based on the plurality of examples and the semantic model; and
provide an indication of whether the second part data includes the feature to be identified.

2. The system of claim 1, wherein the first plurality of examples includes a first subset of examples that are positive examples of the feature to be identified and a second subset of examples that are negative examples of the feature to be identified.

3. The system of claim 1, wherein the part to be manufactured comprises at least one vertex, at least one edge, and at least one face, and the first part data includes data that defines the least one vertex, the at least one edge, or the at least one face.

4. The system of claim 1, wherein the indication indicates that the second part data includes at least one feature instance of the feature to be identified; and
the indication is determined to be a false positive.

5. The system of claim 1, wherein the at least one feature is reclassified as a negative example of the feature to be identified; and
the inductive logic programming module is further configured to:
modify the determined at least one rule based on the reclassified negative example; and
provide an indication that the reclassified at least one feature is a negative example of the feature to be identified based on the modified determined at least one rule.

6. The system of claim 1, further comprising a conversion module configured to:
receive the second part data in a first format, the first format corresponding to a format generated by an application to design the part to be manufactured; and
convert the second part data to a second format, the second format corresponding to a format consumable by the inductive logic programming module.

7. The system of claim 1, wherein the inductive programming logic module is further configured to modify the semantic model to incorporate the determined at least one rule and the provided indication.

8. A method comprising:
establishing, in a machine-readable medium, a semantic model, the semantic model comprising first part data that defines one or more characteristics for a part to be manufactured;
receiving, by at least one processor, a first plurality of examples of a feature to be identified from the part to be manufactured;
receiving, by at least one processor, second part data that defines the part to be manufactured;
determining, by at least one processor, at least one rule that identifies whether the second part data includes the feature to be identified, the at least one rule being determined based on the plurality of examples and the semantic model; and
providing, by at least one processor, an indication of whether the second part data includes the feature to be identified.

9. The method of claim 8, wherein the first plurality of examples includes a first subset of examples that are positive examples of the feature to be identified and a second subset of examples that are negative examples of the feature to be identified.

10. The method of claim 8, wherein the part to be manufactured comprises at least one vertex, at least one edge, and at least one face, and the first part data includes data that defines the least one vertex, the at least one edge, or the at least one face.

11. The method of claim 8, wherein the indication indicates that the second part data includes at least one feature instance of the feature to be identified; and
the indication is determined to be a false positive.

12. The method of claim 11, wherein the at least one feature instance is reclassified as a negative example of the feature to be identified; and
the method further comprises:
modifying the determined at least one rule based on the reclassified negative example; and
providing an indication that the reclassified at least one feature instance is a negative example of the feature to be identified based on the modified determined at least one rule.

13. The method of claim 8, further comprising:
receiving the second part data in a first format, the first format corresponding to a format generated by an application to design the part to be manufactured; and
converting the second part data to a second format, the second format corresponding to a format consumable by the inductive logic programming module.

14. The method of claim 8, further comprising:
modifying the semantic model to incorporate the determined at least one rule and the provided indication.

15. A machine-readable medium storing machine-executable instructions thereon that, when executed by a machine, cause the machine to perform operations comprising:
receiving, by at least one processor, a first plurality of examples of a feature to be identified from a part to be manufactured;
receiving, by at least one processor, second part data that defines the part to be manufactured;
determining, by at least one processor, at least one rule that identifies whether the second part data includes the feature to be identified, the at least one rule being determined based on the plurality of examples and a semantic model, the semantic model comprising first part data that defines one or more characteristics for the part to be manufactured; and
providing, by at least one processor, an indication of whether the second part data includes the feature to be identified.

16. The machine-readable medium of claim 15, wherein the first plurality of examples includes a first subset of examples that are positive examples of the feature to be identified and a second subset of examples that are negative examples of the feature to be identified.

17. The machine-readable medium of claim 15, wherein the part to be manufactured comprises at least one vertex, at least one edge, and at least one face, and the first part data includes data that defines the least one vertex, the at least one edge, or the at least one face.

18. The machine-readable medium of claim 15, wherein:
the indication comprises a false positive that indicates that the second part data includes at least one feature instance of the feature to be identified;
the at least one feature instance is reclassified as a negative example of the feature to be identified; and
the operations further comprise:
modifying the determined at least one rule based on the reclassified negative example; and
providing an indication that the reclassified at least one feature instance is a negative example of the feature to be identified based on the modified determined at least one rule.

19. The machine-readable medium of claim 15, wherein the operations further comprise:
receiving the second part data in a first format, the first format corresponding to a format generated by an application to design the part to be manufactured; and
converting the second part data to a second format, the second format corresponding to a format consumable by the inductive logic programming module.

20. The machine-readable medium of claim 15, wherein the operations further comprise:
modifying the semantic model to incorporate the determined at least one rule and the provided indication.
